(19) United States
(12) Patent Application Publication
(10) Pub. No.: US 2008/0203072 A1
(43) Pub. Date: Aug. 28, 2008

(54) Method and a Device for Providing Feedback on Weaving Parameters

(75) Inventors: Fredrik Hedenfalk, Vasteras (SE); Pavel Lemarinier, Vasteras (SE)

Correspondence Address: VENABLE LLP, P.O. BOX 34385, WASHINGTON, DC, 20043-9998, US

(73) Assignee: ABB AB, Vasteras (SE)

(21) Appl. No.: 11/629,538

(22) PCT Filed: Jun. 2, 2005
(86) PCT No.: PCT/SE05/00837

§ 371 Date: Dec. 17, 2007

(30) Foreign Application Priority Data
Jun. 14, 2004 (SE) 0401542-6

(51) Int. Cl. B23K 9/127; G05B 13/04

(52) U.S. Cl. 219/124.1; 219/125.1; 700/250

(57) ABSTRACT

A method and a device for providing feedback on weaving parameters in connection with programming an industrial robot provided with a tool to perform a weaving movement. The device includes a simulation unit receiving the weaving parameters and on basis thereof performing a simulation of the weaving movement with a mathematical model of the weaving movements, a graphical unit receiving the calculated trace and on basis thereof producing a graphical representation of the weaving movement, and a display unit displaying the graphical representation of the weaving movement.

### FIELD OF THE INVENTION

The present invention relates to a method and a device for providing feedback on weaving parameters in connection with programming an industrial robot to perform a weaving movement. The invention is particularly useful in connection with programming an industrial robot to perform a welding process, such as arc welding. However, the invention is also useful in connection with programming the robot to perform any process including a weaving movement, such as gluing.

### PRIOR ART

Weaving is a movement superimposed on the basic path of the process. That means that the robot moves the tool essentially along the basic path, and at the same time the tool performs a weaving movement. The weaving movement repeats a weaving pattern having a predetermined weave shape.

When an industrial robot is programmed to carry out a weaving movement, weaving data has to be created as an input to the robot programming. The weaving pattern is defined by the weaving data. When creating the weaving data, the user assigns values to a plurality of weaving parameters. The number of weaving parameters to be set depends on the process and the tool used. For example weaving data for an arc welding process may comprise thirteen weaving parameters. For example, the weaving parameters are the weave shape type, the weave type, the weave cycle, the weave width, and the weave height. The weaving data may also comprise other parameters more precisely specifying the shape of the weave. The values of the weaving parameters differ between various process applications.

Accordingly, weaving with an industrial robot includes many possible combinations of weaving parameters, all resulting in different weaving patterns. In order to find an optimal weaving pattern in accordance with the process requirements, weaving data has to be tested by running the weaving program on the robot, and studying the movements of the robot. The operator has to try the weaving data through experience to verify that the weaving pattern is the desired. Therefore, when programming an industrial robot to carry out a weaving movement for a specific process application it is troublesome and time consuming to find an optimal weaving pattern.

### OBJECTS AND SUMMARY OF THE INVENTION

The object of the present invention is to make it easier and faster for the operator to find an optimal weaving pattern for a specific process application.

According to one aspect of the invention this object is achieved by a method as defined in claim 1.

The method comprises the following steps: receiving weaving parameters, performing a simulation of the weaving movement based on the received weaving parameters and a mathematical model of the weaving movement, producing a graphical representation of the weaving movement based on said simulation, and displaying said graphical representation of the weaving movement. Performing a simulation of the weaving movement comprises calculating the trace to be followed by the tool during the weaving movement based on the received weaving parameters and the mathematical model of the weaving movement. The graphical representation of the weaving movement is for example provided in 3D or in projection on a plane surface.

The weaving movement of the tool describes a weaving pattern. The mathematical model comprises a description of how the parameters affect the weaving pattern, for example in the form of equations and/or relations between the parameters and the weaving pattern. When the operator inputs a set of weaving parameters, or selects a predefined set of parameters, the trace of the tool, i.e. the weaving pattern, is visualized on a display screen. Thus, it is possible for the user to choose a set of weaving parameters and view the achieved weaving pattern on the display screen, without having to run the robot. The method can be used off-line on a personal computer, or integrated in a portable teach-pendant unit. Thanks to the invention the time for preparing a robot path including weaving, such as a welding path, is considerably reduced.

When the user is satisfied with the displayed shape of the weaving movement he approves the weaving shape and upon receiving the approval from the user, weaving data for the robot is created based on the weaving parameters, on which the present simulation is based. Thus, the weaving data does not have to be created until the user has approved the weaving pattern displayed.

According to one embodiment of the invention it is possible to select between a plurality of weave shape types and a mathematical model is provided for each weave shape type. In this embodiment one of the weaving parameters is the type of the shape of the weaving pattern. There is number of predefined wave shapes types for the user to choose from. For each weave shape type a mathematical model is defined. Which mathematical model to be used is determined base on which wave shape type the user selects.

According to an embodiment of the invention the method comprises receiving one or more adjusted weaving parameters, and the steps of the method is repeated based on the new adjusted parameters. Preferably, the values assigned to the weaving parameters are displayed together with the graphical representation of the weaving movement. If the operator is not satisfied with the weaving pattern visualized on the display device, he may adjust one or more of the parameters and the new weaving pattern is visualized on the display device. This embodiment of the invention makes it easier and faster for the operator to find an optimal weaving pattern for a specific process application.

To make it easier to change the numerical value of a selected weaving parameter a user interaction member, such as a scrollbar, is displayed on the display screen. Thus, the user can adjust the values of the weaving parameters until he is satisfied with the weaving pattern. The user gets an immediate visual feedback on any adjustment of a parameter.

According to an embodiment of the invention weaving data for the robot is created upon command, based on the received and adjusted weaving parameters. When the operator is satisfied with the displayed weaving pattern he indicates this, for example by activating a software button, and weaving data for the robot is automatically created. The creation of weaving data comprises for example the creation of a variable, an instance or a file comprising the parameters and their values. The weaving data created is ready for being loaded directly into the control system of the robot. This embodiment further reduces the time required for programming a robot path including a weaving pattern.

According to an embodiment of the invention the method comprises displaying the graphical representation of the weaving movement from different viewing angles in dependence of user commands. Thus, it is possible for the operator to view the weaving pattern from different angles.

The weaving movement comprises a repetitive pattern of a weave shape. The weaving parameters comprise at least the weave shape type, the weave cycle, the weave width, and the weave height. For example the weave shape type is any of Zig-zag, V-shape or Triangular.

According to an embodiment of the invention the method comprises calculating a plurality of points on the trace based on the received weaving parameters and the mathematical model of the weaving movements, and the graphical representation of the weaving movement is produced based on the calculated points. In a preferred embodiment, the points calculated are a plurality of breakpoints on the weave shape, and the mathematical model of the weaving movements comprises the weave shape describes as a plurality of linear segments, wherein each segment is represented by a vector having a start point and an end point, and said calculated breakpoints are the start and end points of said vectors. This is a simple and straightforward method to calculate the trace of the tool.

According to a further aspect of the invention, the object is achieved by a computer program directly loadable into the internal memory of a computer or a processor, comprising software code portions for performing the steps of the method according to the invention, when said program is run on a computer. The computer program is provided either on a computer readable medium or through a network, such as the Internet.

According to another aspect of the invention, the object is achieved by a computer readable medium having a program recorded thereon, when the program is to make a computer perform the steps of the method according to the invention, and said program is run on the computer.

The method according to the invention is preferably used for visualizing a weaving movement and/or optimizing weaving parameters in connection with programming of an industrial robot.

According to another aspect of the invention this object is achieved by a device as defined in claim 19. Such a device is characterized in that it comprises a simulation unit receiving said weaving parameters and on basis thereof performing a simulation of the weaving movement by means of a mathematical model of the weaving movements, a graphical unit producing a graphical representation of the weaving movement based on the simulation of the movement, and a display unit displaying the graphical representation of the weaving movement.

A device according to the invention assists the operator to visualize the weaving movement without having to run the robot program on the robot. The display unit comprises a display screen, for instance the display screen of a portable teach pedant or of an external computer.

### BRIEF DESCRIPTION OF THE DRAWINGS

The invention will now be explained more closely by the description of different embodiments of the invention and with reference to the appended figures.

FIG. 1a-c shows an example of the weave shape of the weaving pattern for zigzag weaving.

FIG. 2a-c shows an example of the weave shape of the weaving pattern for V-shaped weaving.

FIG. 3a-c shows an example of the weave shape of a weaving pattern for triangular weaving.

FIG. 4 shows an example of how a weaving shape of a weave cycle is divided into a plurality of segments.

FIG. 5 shows a general block diagram over a device according to an embodiment of the invention.

FIG. 6 shows a first example of a view displaying the graphical representation of the weaving movement.

FIG. 7 shows a second example of a view displaying the graphical representation of the weaving movement.

FIG. 8a shows third example of a view displaying the graphical representation of the weaving movement.

FIG. 8b shows a two dimensional projection of the trace of a robot tool on a plane.

FIG. 8c shows touch-screen boxes for selections of predefined weaving pattern.

FIG. 9 illustrated by means of a flow chart, a general method according to the invention.

### DETAILED DESCRIPTION OF PREFERRED EMBODIMENTS OF THE INVENTION

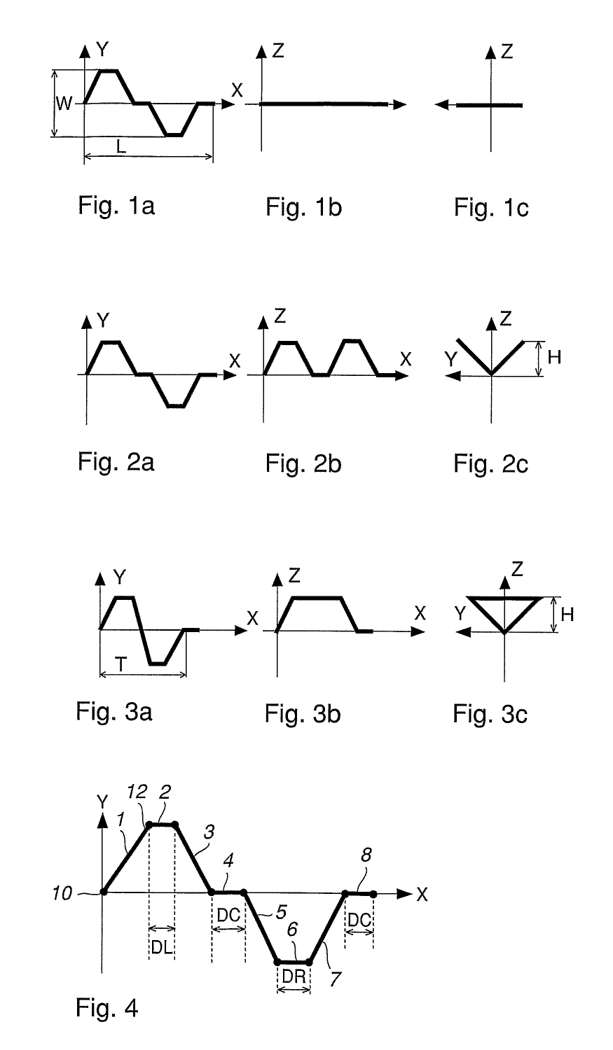

A weaving movement is defined by weaving data comprising a plurality of weaving parameters. For example in arc welding the weaving data comprises 18 parameters to be set. Some of the parameters of the weaving data depend of the configuration of the robot. The main parameter to be set is the weave shape type. In this embodiment there are three weave shape types to choose from, as illustrated in FIGS. 1a-3c. FIG. 1a-c shows a zigzag shaped weaving pattern, FIG. 2a-c shows a V-shaped weaving pattern, and FIG. 3a-c shows a triangular shaped weaving pattern. As shown in FIG. 1a-c the zigzag weaving results in weaving horizontal to the seam. The height of the weave shape is zero for zigzag weaving.

Another weaving parameter is the type of weaving in the welding phase. For a 6-axes robot, the weaving types are: geometric weaving (0), i.e. all axes are used during the weaving, wrist weaving (1), rapid weaving (2) using axis 1, 2 and 3, and rapid weaving (3) using axis 4, 5 and 6. Another important parameter is the weave cycle. There are two meanings of the weave cycle parameter: the length of the weave cycle, and weaving frequency. The weave cycle is defined as the length L of the weave cycle in the weld phase for weaving types 0 and 1, and as the frequency f=1/T of the weave cycle for weaving types 2 and 3. T is the weave cycle time. Other important parameters are the width W and the height H of the weaving pattern.

FIG. 4 shows more weaving parameters such as dwell left DL, which is the length of the dwell used to force the TCP (Tool center point) to move in the direction of the seam at the left turning point of the weave, dwell center DC, which is the length of the dwell used to force the TCP to move in the direction of the seam at the center point of the weave, and dwell right DR, which is the length of the dwell used to force the TCP to move in the direction of the seam at the right turning point of the weave. Other parameters to be set are for example the weave direction angle, weave tilt angle, weave orientation angle, and weave centre bias.

For the calculation of the trace to be followed by the tool during the weaving movement, a mathematical model of the weaving movement, i.e. the weaving pattern, is provided. A mathematical model is developed for each of the weave shape types. To provide a mathematical model of a weave shape, the weave shape is divided into a plurality of linear segments 1-8, as shown in FIG. 4. The mathematical model comprises a plurality of vectors, each vector representing one of said linear segments 1-8. A vector is represented with the coordinates of its start and end point. For example segment 1 is represented with the coordinates of its start point 10 and its end point 12. For many of the vectors, the end point of the vector is the start point for the next vector. The points of the vectors are breakpoints on the weave shape. The mathematical model further comprises equations and relations describing how each of the weaving parameter influences the position of the breakpoints, i.e. the start and end points of the vectors.

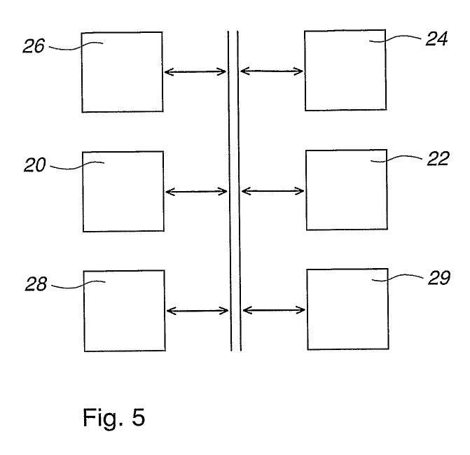

FIG. 5 shows a block diagram over a device according to an embodiment of the invention. The device comprises a simulation unit 20 adapted to perform a simulation of the weaving movement, i.e. to calculate the trace to be followed by the tool during the weaving movement, based on received weaving parameters by means of a mathematical model of the weaving movements, a graphical unit 22 receiving the calculated trace and on basis thereof producing a graphical representation of the weaving movement, a display unit 24 displaying the graphical representation of the weaving movement, and a memory unit 26 for storing the weaving parameters and computer program instructions to carry out the method of the invention. The simulation unit 24 comprises a central processing unit and calculates the breakpoints on the weave shape. The graphical unit 22 creates a graphical representation of the weaving movement based on the calculated breakpoints by means of known methods and commercially available programs for generating graphics by means of a computer.

The device further comprises user input means 28. The device may comprise any normal input means, such as a keyboard, a keypad, a touch screen, a computer mouse or any other pointing means. The device further comprises a weaving data creator 29, which upon receiving an approval from a user creates weaving data for the robot based on the weaving parameters on which the present simulation is based. The creation of data comprises for example the creation of a variable, an instance or a file comprising the parameters and their values. The weaving data is then used by the control system of the robot for the calculation of robot movement to enable the robot to carry out the desired weaving movement.

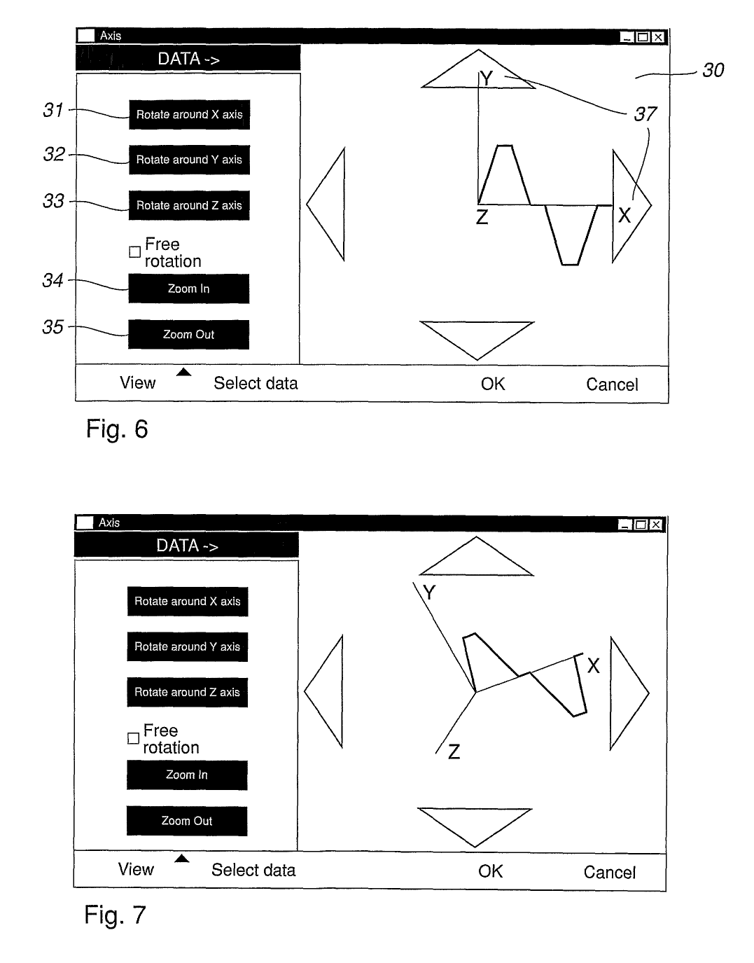

FIG. 6 shows an example of a view displaying the graphical representation of the weaving movement. The view comprises a visualization window 30 for displaying the graphical representation of the weaving movement. The view displayed comprises a plurality of interaction means 31-35, which upon activation changed the view of the weaving movement. The interaction means 31-35 for example represents the following functions: rotate around the X-axes, rotate around the Y-axes, rotate around the Z-axes, zoom in and zoom out. The interaction means are for example software buttons, which are activated by pointing and/or clicking on them by a pointing device. Thus, the user can control the view displayed by using the zooming and rotating functions available. FIG. 7 shows the same weaving movement as FIG. 7, but the pattern is rotated. The view displayed is also provided with means 37 to move the view in different directions.

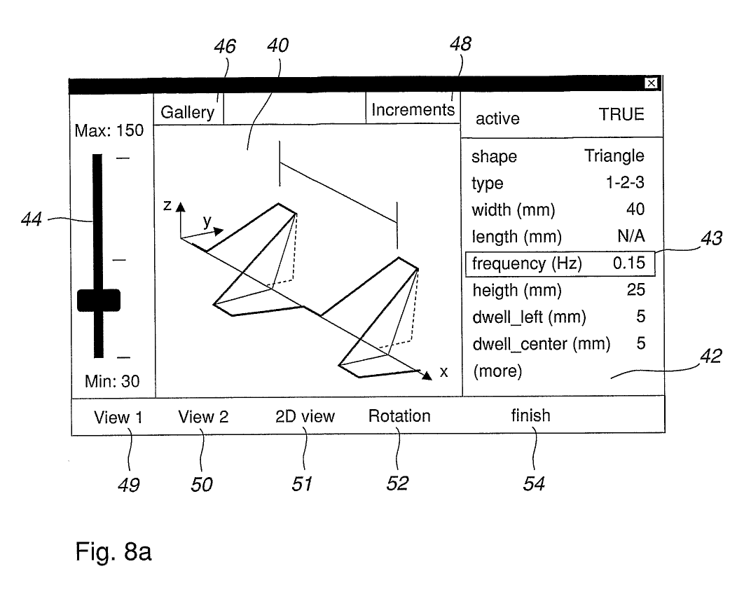

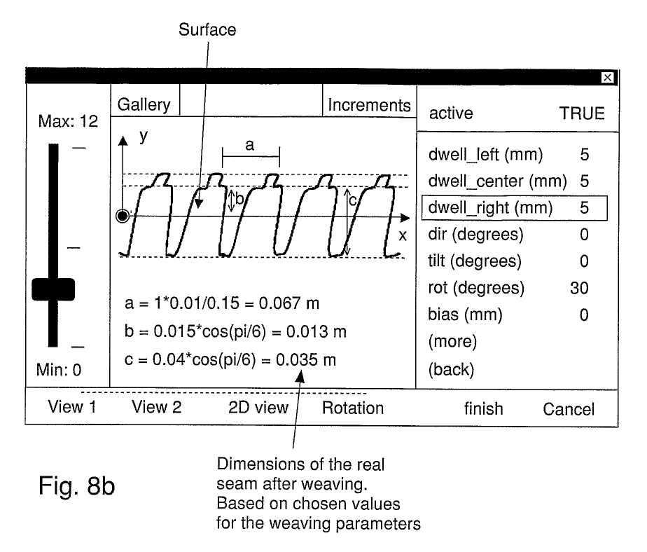

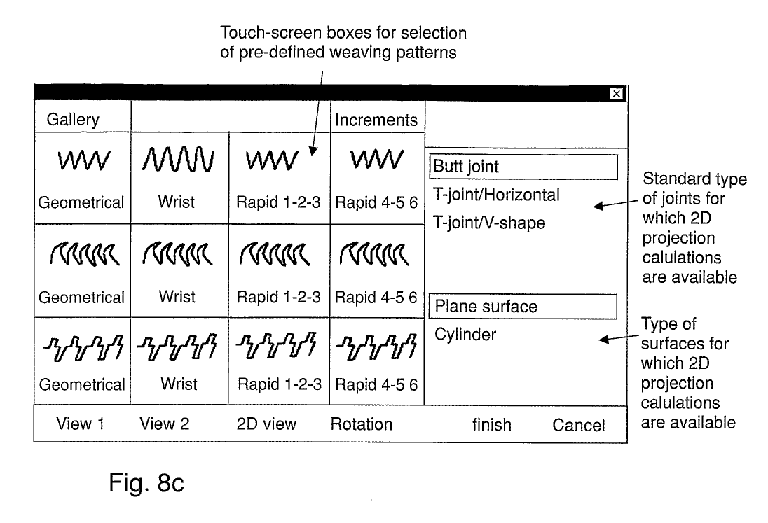

FIG. 8a shows another example of a view displaying the graphical representation of the weaving movement. The view comprises a visualization window 40 for displaying the graphical representation of the weaving movement. The view comprises a box 42 displaying all the weaving parameters and the values assigned to each parameter. The operator selects which of the parameters to be modified. In this example the parameter frequency 43 is selected. The view also comprises a scrollbar 44 for changing a selected weaving parameter. The user selects one of the parameters in the box 42 for example by pointing or clicking at the parameter. When a parameter is selected it is possible for the user to change its value by means of the scrollbar 44. When the user changes the value of a parameter, the view of the weaving movement shown in the box 40 is changed in dependence of the change of the parameter. Accordingly, the user, by trial and error, can change the parameters until he is satisfied with the resulting weaving movement. The user receives an immediate visual feedback upon changing a parameter.

The view further comprises a reference menu 46 of predefined weaving patterns views and data. The reference menu 46 (denoted Gallery) comprises predefined projections of different kinds of weaving pattern on plane surfaces and representations of some typical 3D weaving patterns with corresponding weaving parameters. By clicking on one of the icons in that menu the user gets a static or animated visualization of the trace of the tool, for example of the welding gun, both in 3D and in projection on a plane surface together with a summary of the numerical values for the corresponding weaving parameters. The view is also provided with means 48 for choice of increment steps for the parameter setting with the scrollbar. The view further comprises means 49-52 for changing to other views including 2D projections in the x,y,z plane and rotated views.

The device includes a weaving data creator, creating weaving data for the robot based on the received and adjusted weaving parameters. The view displayed comprises an interaction means 54, in the form of a software button, for commanding the creation of weaving data. In the following the interaction means 54 is denoted a finish-button. When the user activates the finish-button, by for example pointing at it with the pointing device, a signal is send to a software module for creating weaving data based on the parameters set by the user. The creation of data comprises for example the creation of a variable, an instance or a file comprising the parameters and their values. Accordingly, the user adjusts the values of the weaving parameters until he is satisfied with the weaving pattern displayed on the display device, and then he activates the finish-button and weaving data for the robot is created.

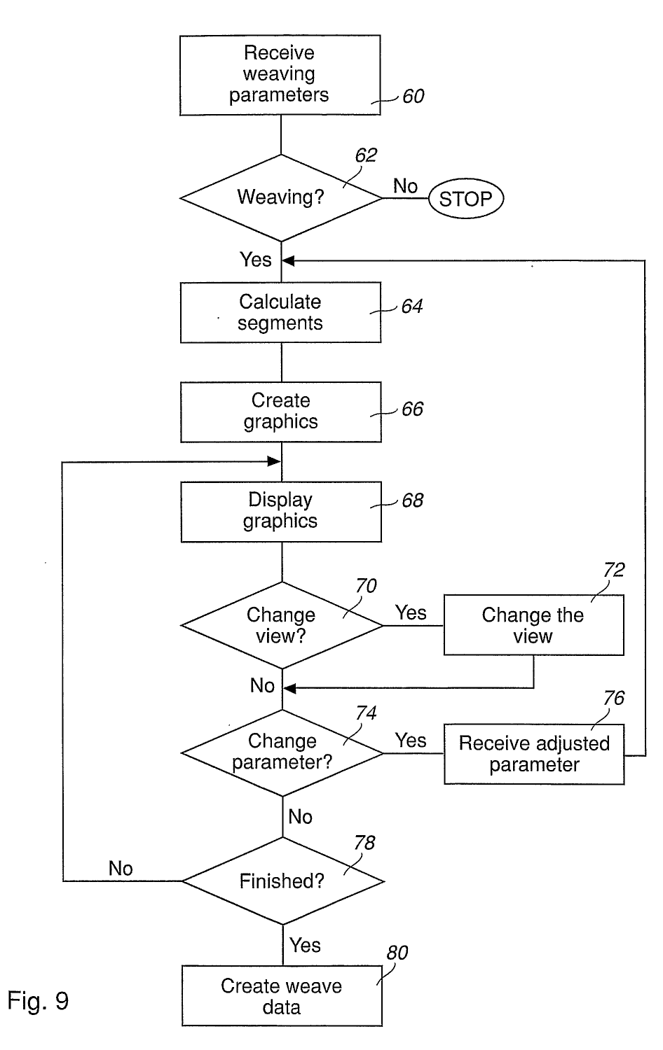

FIG. 9 is a flow chart illustration of the method and the computer program product according to an embodiment of the present invention. It will be understood that each block of the flow chart can be implemented by computer program instructions. As shown in block 60, values for the weaving parameters are received. One of the weaving parameters contains information about the weave shape of the weaving movement. The values are for example provided as user inputs, or from a previously created file of weaving data. At first, the weaving data received is examined and it is decided whether it is weave or no-weave, block 62. If it is weave, the program goes on and calculates the segments of the selected weave shape type, based on the other received weaving parameters and a mathematical model of the selected weave shape type, block 64.

The calculated breakpoints are converted into graphics representing the weaving pattern, block 66, and a view including the graphics and user interaction means are displayed on the display device, 68. In order to evaluate the weaving pattern, the user may change the view by zooming and rotating the view about the x, y or z-axis. The user orders changes of the view by activating the interaction means displayed, block 70, 72. The user may change the value of any parameter, block 74. An adjusted value of the parameter is received, block 76, and new breakpoints are calculated, new graphics are created based on the new breakpoints, and the new graphics are displayed on the display screen. The user may continue to change the view and adjust the parameters until he is satisfied with the weaving pattern. When the user is finished he approves the shape of the weaving movement. In this example the user approved the shape of the weaving movement by pushing the finish-button. The program receives a finish signal from the finish button, block 78. When receiving the finish-signal, weaving data is created based on the present values of the weaving parameters block 80.

The device according to the invention can be used off-line on a Personal computer or integrated in a GTPU (Graphical Teach Pendant Unit).

1. A method for providing feedback on weaving parameters in connection with programming an industrial robot provided with a tool to perform a weaving movement, the method comprising:
a) receiving weaving parameters,
b) performing a simulation of the weaving movement based on the received weaving parameters and a mathematical model of the weaving movement,
c) producing a graphical representation of the weaving movement based on said simulation, and
d) displaying said graphical representation of the weaving movement.

2. The method according to claim 1, further comprising:
receiving at least one adjusted weaving parameter and repeating the steps b-d based on the adjusted parameter.

3. The method according to claim 2, further comprising:
displaying in the same view as the graphical representation of the weaving movement, a user interaction member and upon activation of the user interaction member the numerical value of a selected weaving parameter is adjusted.

4. The method according to claim 3, wherein said user interaction member is a scrollbar for adjusting the numerical value of the selected weaving parameter.

5. The method according to claim 3, further comprising:
displaying the weaving parameters,
selecting one of the weaving parameters and
upon selection of the weaving parameter displaying said user interaction means.

6. The method according to claim 2, further comprising:
upon command creating weaving data for the robot based on the received and adjusted weaving parameters.

7. The method according to claim 1, further comprising:
upon user control displaying the graphical representation of the weaving movement from different viewing angles.

8. The method according to claim 1, wherein said weaving parameters includes a weave shape type, and that said trace is calculated based on a mathematical model of the weave shape type.

9. The method according to claim 8, wherein said weaving parameters comprise a weave cycle, a weave width and a weave height.

10. The method according to claim 1, wherein said graphical representation of the weaving movement is provided in 3D.

11. The method according to claim 1, wherein performing a simulation of the weaving movement comprises calculating a plurality of points on a trace to be followed by the tool during the weaving movement based on the received weaving parameters and a mathematical model of the weaving movements, and wherein said graphical representation of the weaving movement is produced based on said calculated points.

12. The method according to claim 11, wherein the weaving movement comprises a plurality of repetitive movements each representing a weave shape, and said calculation of points comprises calculating the positions of a plurality of breakpoints on the weave shape.

13. The method according to claim 12, wherein said mathematical model of the weaving movements comprises the weave shape describes as a plurality of linear segments, wherein each segment is represented by a vector having a start point and an end point, and said calculated breakpoints are the start and end points of said vectors.

14. The method according to claim 8, wherein said weave shape types is any of Zigzag, V-shape or Triangular.

15. The method according to claim 1, further comprising:
receiving an approval from a user and upon receiving said approval creating weaving data for the robot based on said weaving parameters.

16. A computer program product, comprising:
a computer readable medium; and
computer program instructions recorded on the computer readable and executable by a processor for performing the steps of
receiving weaving parameters,
performing a simulation of the weaving movement based on the received weaving parameters and a mathematical model of the weaving movement,
producing a graphical representation of the weaving movement based on said simulation, and
displaying said graphical representation of the weaving movement.

17. (canceled)

18. Use of a method according to claim 1 for visualizing weaving movements in connection with programming of an industrial robot.

19. A device for providing feedback on weaving parameters in connection with programming an industrial robot provided with a tool to perform a weaving movement, the device comprising
a simulation unit receiving said weaving parameters and on basis thereof performing a simulation of the weaving movement by means of a mathematical model of the weaving movement,
a graphical unit producing a graphical representation of the weaving movement based on said simulation, and
a display unit displaying said graphical representation of the shape of weaving movement.

20. The device according to claim 19, further comprising:
a weaving data creator, which upon receiving an approval from a user creates weaving data for the robot based on said weaving parameters.

21. The device according to claim 19, further comprising:
means for adjusting the weaving parameters, wherein said simulation unit is adapted for receiving the adjusted weaving parameters and on basis thereof performing the simulation.

22. The device according to claim 21, said means for adjusting the weaving parameters comprises means for generating a graphical interface displaying the weaving parameters and a user interaction member for upon activation adjusting the numerical value of a selected weaving parameter, and wherein said display unit is adapted for displaying the user interaction member in the same view as the graphical representation of the weaving movement.

23. The device according to claim 22, wherein said user interaction means is a scrollbar for adjusting the numerical value of the selected weaving parameter.

24. The device according to claim 21, further comprising:
a weaving data creator, creating upon command weaving data for the robot based on the received and adjusted weaving parameters.

25. The device according to claim 19, further comprising:
means for displaying the graphical representation of the weaving movement from different viewing angles.

26. The device according to claim 19, wherein said weaving parameters comprises the weave shape type, the weave cycle and the weave with.

27. The device according to claim 19, wherein said waiving parameters comprises the weave height and said graphical unit is adapted for producing a 3D-graphical representation of the weaving movement.

28. The device according to claim 19, wherein the weaving movement comprises a plurality of repetitive movements each representing a weave shape, and wherein said simulation unit is adapted for calculating a plurality of breakpoints on said weave shape based on the weaving parameters and said mathematical model.

29. The device according to claims 28, wherein said mathematical model of the weaving movements comprises the weave shape described as a plurality of linear segments wherein each segment is represented by a vector having a start point and an end point, and said calculated breakpoints are the start and end points of said vectors.

30. The device according to claim 26, wherein said weave shape type is any of Zigzag, V-shape or Triangular.

31. The device according to claim 19, wherein said simulation unit is receiving weaving parameters including a selected weave shape type, and on basis thereof calculating the trace to be followed by the tool during the weaving movement by means of a plurality of mathematical model representing different weave shape types.

32. Use of a method according to claim 1 for optimizing weaving parameters in connection with programming of an industrial robot.
